(19) United States
(12) Patent Application Publication
(10) Pub. No.: US 2025/0079786 A1
(43) Pub. Date: Mar. 6, 2025

(54) MANUFACTURING METHOD OF CONNECTOR WITH CIRCUIT BOARD

(71) Applicant: YAZAKI CORPORATION, Tokyo (JP)

(72) Inventor: Yuya Kishibata, Makinohara-shi (JP)

(21) Appl. No.: 18/793,707

(22) Filed: Aug. 2, 2024

(30) Foreign Application Priority Data
Aug. 28, 2023 (JP) 2023-138057

(51) Int. Cl. H01R 43/20; H01R 12/58

(52) U.S. Cl. CPC H01R 43/205; H01R 12/585

(57) ABSTRACT

A method for manufacturing a board-equipped connector, includes abutting a compliant portion of a press-fit terminal of a connector against an inner peripheral surface of a circuit board such that a tip end portion of the through hole in the press-fit direction is disposed within the press-fit hole, press-fitting the compliant portion into the press-fit hole, and stopping press-fitting the compliant portion into the press-fit hole such that a base end portion of the through hole in the press-fit direction is disposed upper than an upper surface of the circuit board.

### CROSS-REFERENCE TO RELATED APPLICATIONS

This application is based on and claims priority under 35 USC 119 from Japanese Patent Application No. 2023-138057 filed on Aug. 28, 2023.

### TECHNICAL FIELD

The present invention relates to a method for manufacturing a board-equipped connector.

### BACKGROUND ART

In the related art, a board-equipped connector including a circuit board and a connector mounted on the circuit board has been proposed. In one board-equipped connector of the related art, a connector includes a press-fit terminal and a housing that holds the press-fit terminal, and the connector is mounted on the circuit board such that a compliant portion of the press-fit terminal is press-fitted into a press-fit hole of the circuit board (for example, refer to Patent Literature 1).

### CITATION LIST

### Patent Literature

Patent Literature 1: JP2020-194636A
Patent Literature 2: JP2022-183630A

### SUMMARY OF INVENTION

In Patent Literature 2, regarding press-fitting of a compliant portion of a press-fit terminal into a press-fit hole of a circuit board, an insertion force of the compliant portion into the press-fit hole is reduced by offsetting a straight portion of the compliant portion between an outer side and an inner side. On the other hand, in a state in which the compliant portion is completely press-fitted into the press-fit hole, a portion where the compliant portion is not deformed is disposed in the press-fit hole. This may result in a large load placed on the press-fit hole and ultimately to the circuit board, which may cause problems with the circuit board.

The present invention has been made in view of the above-described circumstances, and an object of the present invention is to provide a method for manufacturing a board-equipped connector that can reduce a load on a circuit board relating to press-fitting of a press-fit terminal into a press-fit hole of the circuit board.

In order to achieve the above-described object, a method for manufacturing a board-equipped connector according to the present invention is characterized as follows:

A method for manufacturing a board-equipped connector,
the board-equipped connector including a circuit board having a press-fit hole, and a connector mounted on the circuit board,
the connector including
   a press-fit terminal having one end side press-fitted into the press-fit hole of the circuit board in a press-fit direction, and
   a housing holding the press-fit terminal,
the press-fit terminal including
   a compliant portion having both side portions disposed in a width direction of the press-fit terminal and pressed against an inner peripheral surface of the press-fit hole, the width direction intersecting the press-fit direction,
   the compliant portion having a through hole penetrating in a plate thickness direction of the press-fit terminal and extending along the press-fit direction, the plate thickness direction intersecting the press-fit direction and the width direction,
the method including mounting the connector to the circuit board, and
the mounting including:
   abutting the compliant portion against the inner peripheral surface such that a tip end portion of the through hole in the press-fit direction is disposed within the press-fit hole,
   press-fitting the compliant portion into the press-fit hole, and
   stopping press-fitting the compliant portion into the press-fit hole such that a base end portion of the through hole in the press-fit direction is disposed upper than an upper surface of the circuit board.

According to the present invention, in the mounting step of the connector on the circuit board, the tip end portion of the through hole in the press-fit direction is positioned in the press-fit hole at the beginning of contact between the compliant portion and the inner peripheral surface of the press-fit hole, and the base end portion of the through hole in the press-fit direction is disposed closer to the base end side in the press-fit direction than the base end side surface in the press-fit direction of the circuit board in the state in which the connector is completely mounted on the circuit board. Here, when the compliant portion of the press-fit terminal is press-fitted (inserted) into the press-fit hole of the circuit board, the compliant portion is elastically deformed such that the through hole becomes smaller in the width direction. That is, since the tip end portion of the through hole is positioned within the press-fit hole at the beginning of the contact, the compliant portion can be easily elastically deformed, and in the mounting completed state, the base end portion of the through hole is disposed closer to the base end side in the press-fit direction than the base end side surface of the circuit board, so that only a repulsive force of the compliant portion (that is, a restoring force from the elastic deformation) is applied to the inner peripheral surface of the press-fit hole. As described above, according to the present invention, since only the repulsive force is applied to the circuit board by disposing an elastically deformable portion of the compliant portion in the press-fit hole of the circuit board, it is possible to reduce a load on the circuit board caused by the press-fitting of the press-fit terminal into the press-fit hole of the circuit board.

The present invention has been briefly described above. Further, details of the present invention can be further clarified by reading modes (hereinafter, referred to as “embodiments”) for carrying out the invention to be described below with reference to the accompanying drawings.

### BRIEF DESCRIPTION OF DRAWINGS

Exemplary embodiment(s) of the present invention will be described in detail based on the following figures, wherein:

FIG. 1 is a front view of a board-equipped connector obtained by a method for manufacturing a board-equipped connector according to an embodiment of the present invention;

FIG. 2 is a sectional view of a connector constituting the board-equipped connector illustrated in FIG. 1;

FIG. 3 is a perspective view of a housing constituting the connector illustrated in FIG. 2;

FIG. 4 is a front view of a terminal constituting the connector illustrated in FIG. 2;

FIG. 5 is a first view illustrating the method for manufacturing a board-equipped connector, and is a sectional view illustrating a mode of a terminal relative to the board in a state in which the connector is being mounted on the board; and

FIG. 6 is a second view illustrating the method for manufacturing a board-equipped connector, and is a sectional view illustrating a mode of the terminal relative to the board in a state in which the connector is completely mounted on the board.

### DESCRIPTION OF EMBODIMENTS

Hereinafter, a method of manufacturing a board-equipped connector 1 according to an embodiment of the present invention will be described with reference to the drawings.

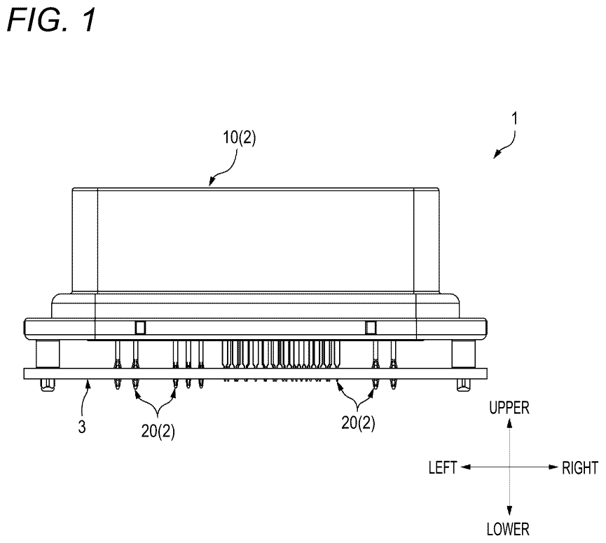

Hereinafter, for convenience of description, as illustrated in FIG. 1 or the like, “front”, “rear”, “left”, “right”, “upper”, and “lower” are defined. A “front-rear direction”, a “left-right direction”, and an “upper-lower direction” are orthogonal to one another. The upper-lower direction corresponds to a “press-fit direction” according to the present invention, and the press-fit direction refers to a direction in which a press-fit terminal 20 is press-fitted into a press-fit hole 3a of a circuit board 3. In addition, an upper side in the upper-lower direction corresponds to a “base end side” in the press-fit direction, and a lower side in the upper-lower direction corresponds to a “tip end side” in the press-fit direction. The left-right direction corresponds to a “width direction” according to the present invention, and the width direction corresponds to a width direction of the press-fit terminal 20. The front-rear direction corresponds to a “plate thickness direction” according to the present invention, and the plate thickness direction refers to a plate thickness direction of the press-fit terminal 20.

As illustrated in FIG. 1, the board-equipped connector 1 includes a connector 2 and the circuit board 3 on which the connector 2 is mounted. The connector 2 is a so-called printed circuit board (PCB) connector, and is configured to be fitted to a counterpart connector (not illustrated). The connector 2 includes a housing 10 and a plurality of press-fit terminals 20. As will be described later, the circuit board 3 is provided with a plurality of press-fit holes 3a.

In the board-equipped connector 1, the plurality of press-fit terminals 20 are respectively press-fitted into the plurality of press-fit holes 3a, and the connector 2 is mounted on the circuit board 3. Then, the connector 2 mounted on the circuit board 3 (that is, the board-equipped connector 1) is fitted to the counterpart connector, so that a terminal (not illustrated) of the counterpart connector and a conductive pattern (not illustrated) of the circuit board 3 are electrically connected via the press-fit terminals 20. Hereinafter, the connector 2 constituting the board-equipped connector 1 (the housing 10 and the press-fit terminals 20) and the circuit board 3 will be described in this order.

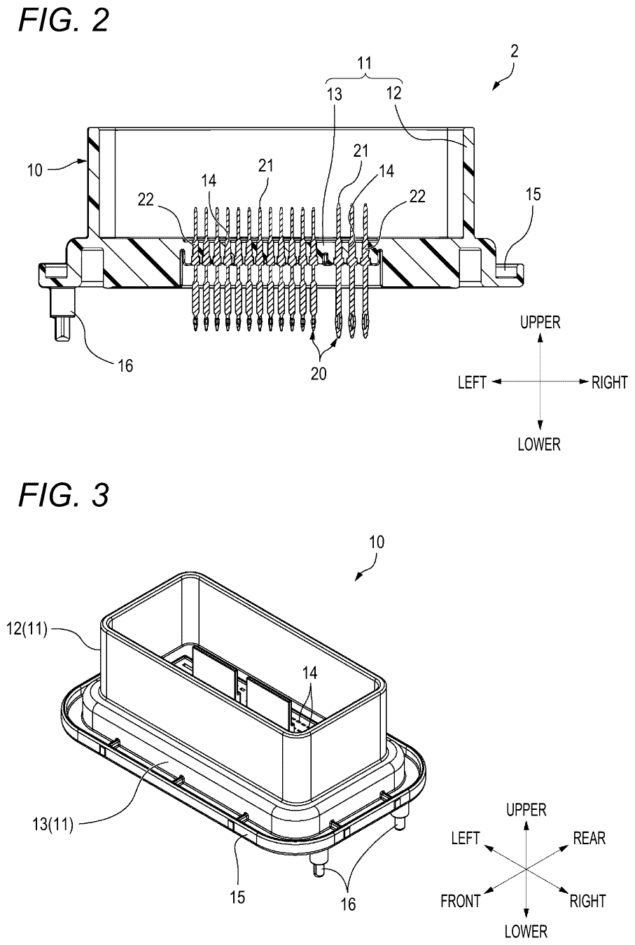

First, the housing 10 will be described. As illustrated in FIGS. 2 and 3, the housing 10 includes a housing body 11 formed in a bottomed substantially rectangular tubular shape. The housing body 11 includes a substantially rectangular tubular peripheral wall 12 and a bottom wall 13 that closes a lower end opening of the peripheral wall 12.

The peripheral wall 12 functions as a so-called hood portion, and a housing (not illustrated) of the counterpart connector is fitted into a tubular hole thereof. A terminal holding hole 14 penetrating in the upper-lower direction is provided in the bottom wall 13, and a press-fit portion 22 of the press-fit terminal 20, which will be described later, is press-fitted into the terminal holding hole 14 so that the press-fit terminal 20 is held in the housing 10.

A flange portion 15 projecting outward of the housing 10 is integrally provided at a lower end of the housing body 11, that is, at a lower end of the bottom wall 13. A fixing protrusion 16 protruding downward is provided on a lower end surface of the flange portion 15. The fixing protrusion 16 is inserted into a fixing hole in the circuit board 3 to be described later, so that the housing 10 (that is, the connector 2) is fixed to the circuit board 3.

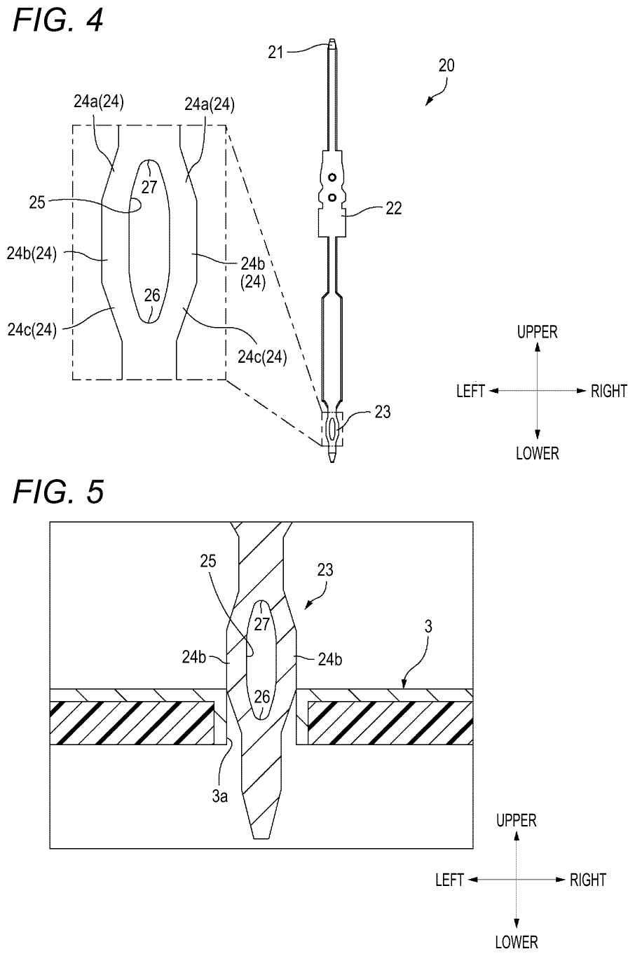

Next, the press-fit terminal 20 will be described. As illustrated in FIG. 4, the press-fit terminal 20 is formed in a rod plate shape extending in the upper-lower direction and having a plate thickness in the front-rear direction. The press-fit terminal 20 is provided with a terminal connecting portion 21, the press-fit portion 22, and a compliant portion 23.

The terminal connecting portion 21 is provided at an upper end portion of the press-fit terminal 20, is a so-called tab-shaped male terminal and is electrically connected to the terminal of the counterpart connector.

The press-fit portion 22 is provided between the terminal connecting portion 21 and the compliant portion 23 in the upper-lower direction, and projects further to the left-right direction beyond other portions (the rod-shaped portion). When the press-fit portion 22 is press-fitted into the terminal holding hole 14 of the housing 10, the press-fit terminal 20 is held by the housing 10.

The compliant portion 23 is provided at a lower end portion of the press-fit terminal 20, and when the compliant portion 23 is press-fitted into the press-fit hole 3a of the circuit board 3, a pair of contact portions 24b, which will be described later, are pressed into contact with an inner peripheral surface of the press-fit hole 3a.

The compliant portion 23 includes a pair of elastic portions 24 spaced apart from each other in the left-right direction and extending in the upper-lower direction. Each of the elastic portions 24 integrally includes a first inclined portion 24a, the contact portion 24b, and a second inclined portion 24c.

The pair of first inclined portions 24a are each provided in an upper side region of the compliant portion 23, and extend obliquely so as to be separated from each other in the left-right direction from an upper side toward a lower side.

The pair of contact portions 24b are each provided in a central region of the compliant portion 23 in the upper-lower direction, and extends substantially linearly along the upper-lower direction so as to connect the first inclined portion 24a and the second inclined portion 24c in the upper-lower direction. Each of the pair of elastic portions 24 is pressed against the inner peripheral surface of the press-fit hole 3a. A length in the left-right direction between contact surfaces of the pair of contact portions 24b with the inner peripheral surface of the press-fit hole 3a is larger than a hole diameter of the press-fit hole 3a.

The pair of second inclined portions 24c are each provided in a lower side region of the compliant portion 23, and extend obliquely so as to approach each other in the left-right direction from the upper side toward the lower side.

As described above, the compliant portion 23 is provided with the pair of first inclined portions 24a, the pair of contact portions 24b, and the pair of second inclined portions 24c, that is, the pair of elastic portions 24, thereby defining a substantially elliptical through hole 25 extending in the upper-lower direction and penetrating in the front-rear direction. A lower end portion 26 of the through hole 25 is positioned on the lower side than the pair of contact portions 24b, and an upper end portion 27 of the through hole 25 is positioned on the upper side than the pair of contact portions 24b.

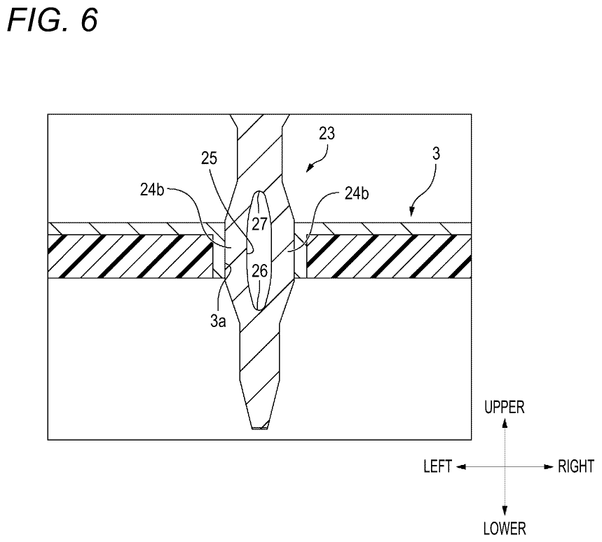

As a result, in the compliant portion 23, in a mounting step of the connector 2 to the circuit board 3 to be described later, the lower end portion 26 of the through hole 25 is positioned within the press-fit hole 3a at the beginning of contact between the pair of contact portions 24b and the inner peripheral surface of the press-fit hole 3a (see FIG. 5), and the upper end portion 27 of the through hole 25 is positioned on the upper side than an upper end surface of the circuit board 3 in a state in which the connector 2 is completely mounted on the circuit board 3 (see FIG. 6).

When the compliant portion 23 configured as described above is press-fitted (inserted) into the press-fit hole 3a of the circuit board 3, the compliant portion 23 is elastically deformed such that the through hole 25 becomes smaller in the left-right direction, that is, the pair of elastic portions 24 approach each other in the left-right direction.

Next, the circuit board 3 will be described. The circuit board 3 is formed in a substantially rectangular flat plate shape, for example. The circuit board 3 is provided with the plurality of press-fit holes 3a into which the plurality of press-fit terminals 20 of the connector 2 are respectively press-fitted (see FIGS. 5 and 6). A conductor pattern (not illustrated) is formed on the circuit board 3, and the press-fit terminal 20 press-fitted into the press-fit hole 3a is electrically connected to the conductor pattern. The circuit board 3 is provided with the fixing hole (not illustrated) into which the fixing protrusion 16 of the housing 10 is inserted. The fixing protrusion 16 is inserted into the fixing hole, so that the housing 10 (that is, the connector 2) is fixed to the circuit board 3.

The connector 2 constituting the board-equipped connector 1 (the housing 10 and the press-fit terminal 20) and the circuit board 3 have been described above. Next, a method for manufacturing a board-equipped connector 1 will be described.

First, the press-fit portions 22 of the plurality of press-fit terminals 20 are respectively press-fitted into the plurality of terminal holding holes 14 of the housing 10. Thus, the press-fit terminals 20 are held in the housing 10, and the connector 2 is completed.

Next, the compliant portions 23 of the plurality of press-fit terminals 20 in the connector 2 are respectively press-fitted into the plurality of press-fit holes 3a of the circuit board 3, and the fixing protrusion 16 of the housing 10 is inserted into the fixing hole of the circuit board 3. Thus, the connector 2 is mounted on the circuit board 3, and the board-equipped connector 1 is completed.

In the mounting step of the connector 2 on the circuit board 3, that is, in a step of press-fitting the compliant portion 23 into the press-fit hole 3a, at the beginning of contact between the compliant portion 23 (that is, the pair of contact portions 24b) and the inner peripheral surface of the press-fit hole 3a, the lower end portion 26 of the through hole 25 is positioned within the press-fit hole 3a (see FIG. 5). Then, in a state in which the mounting of the connector 2 on the circuit board 3 is completed, that is, in a state in which the compliant portion 23 is completely press-fitted into the press-fit hole 3a, the upper end portion 27 of the through hole 25 is positioned on the upper side than the upper end surface of the circuit board 3 (see FIG. 6).

As described above, according to the present embodiment, since the lower end portion 26 of the through hole 25 is positioned in the press-fit hole 3a at the beginning of the contact, the compliant portion 23 can be easily elastically deformed, and in the mounting completed state, the upper end portion 27 of the through hole 25 is disposed on the upper side than the upper end surface of the circuit board (in other words, the upper end portion 27 of the through hole 25 is not positioned in the press-fit hole 3a), so that only a repulsive force of the compliant portion 23 (that is, a restoring force from the elastic deformation) is applied to the inner peripheral surface of the press-fit hole 3a. That is, according to the present embodiment, since only a repulsive force is applied to the circuit board 3 by disposing an elastically deformable portion of the compliant portion 23 (in particular, the pair of easily elastically deformable contact portions 24b) in the press-fit hole 3a of the circuit board 3, it is possible to reduce a load on the circuit board 3 caused by the press-fitting of the press-fit terminal 20 into the press-fit hole 3a can be reduced.

According to the present embodiment, since the length between the contact surfaces of the pair of contact portions 24b with the inner peripheral surface of the press-fit hole 3a is larger than the hole diameter of the press-fit hole 3a, connection reliability between the press-fit terminal 20 (that is, the connector 2) and the circuit board 3 is improved.

According to the present embodiment, since the pair of contact portions 24b are positioned on the upper side than the lower end portion 26 of the through hole 25, and are positioned on the lower side than the upper end portion 27 of the through hole 25, only an intended repulsive force is applied to the circuit board 3, so that it is possible to reduce the load on the circuit board 3 caused by the press-fitting of the press-fit terminal 20 into the press-fit hole 3a of the circuit board 3.

According to the present embodiment, since the through hole 25 has a substantially elliptical shape, adjustment (for example, an amount of elastic deformation or the like) relating to elastic deformation of the compliant portion 23 can be easily made.

According to the present embodiment, not only the load of the circuit board 3 relating to the press-fitting of the press-fit terminal 20 into the press-fit hole 3a can be reduced, but also the insertion force of the press-fit terminal 20 into the press-fit hole 3a can be easily adjusted.

### Other Embodiments

The present invention is not limited to the embodiment described above and can be appropriately modified, improved and the like. In addition, materials, shapes, sizes, numbers, arrangement positions and the like of components in the embodiment described above are freely selected and are not limited as long as the present invention can be implemented.

Here, features of the embodiment of the method for manufacturing a board-equipped connector according to the present invention described above are briefly summarized and listed in the following [1] to [4], respectively.

[1]

A method for manufacturing a board-equipped connector (1),
the board-equipped connector including a circuit board (3) having a press-fit hole (3a), and a connector (2) mounted on the circuit board (3),
the connector (2) including
   a press-fit terminal (20) having one end side (lower side) press-fitted into the press-fit hole (3a) of the circuit board in a press-fit direction, and
   a housing (10) holding the press-fit terminal (20),
the press-fit terminal (20) including
   a compliant portion (23) having both side portions (a pair of contact portions 24b) in a width direction (left-right direction) of the press-fit terminal (20) and pressed against an inner peripheral surface of the press-fit hole (3a), the width direction intersecting with the press-fit direction (upper-lower direction),
   the compliant portion (23) having a through hole (25) penetrating in a plate thickness direction (front-rear direction) of the press-fit terminal (20) and extending along the press-fit direction, the plate thickness direction intersecting the press-fit direction and the width direction,
the method comprising mounting the connector (2) to the circuit board (3), and
the mounting comprising:
   abutting the compliant portion (23) against the inner peripheral surface such that a tip end portion (lower end portion 26) of the through hole (25) in the press-fit direction is disposed within the press-fit hole (3a),
   press-fitting the compliant portion (23) into the press-fit hole (3a), and
   stopping press-fitting the compliant portion (23) into the press-fit hole (3a) such that a base end portion (upper end portion 27) of the through hole (25) in the press-fit direction is disposed upper than an upper surface (upper end surface) of the circuit board (3).

According to the configuration of the above [1], in the mounting, the tip end portion of the through hole in the press-fit direction is disposed in the press-fit hole at the beginning of contact between the compliant portion and the inner peripheral surface of the press-fit hole, and the base end portion of the through hole in the press-fit direction is disposed upper than the upper surface the circuit board in the state in which the connector is completely mounted on the circuit board. Here, when the compliant portion of the press-fit terminal is press-fitted (inserted) into the press-fit hole of the circuit board, the compliant portion is elastically deformed such that the through hole becomes smaller in the width direction. That is, since the tip end portion of the through hole is positioned within the press-fit hole at the beginning of the contact, the compliant portion can be easily elastically deformed, and in the mounting completed state, the base end portion of the through hole is disposed closer to the base end side in the press-fit direction than the base end side surface of the circuit board, so that only a repulsive force of the compliant portion (that is, a restoring force from the elastic deformation) is applied to the inner peripheral surface of the press-fit hole. As described above, according to the above configuration, since only the repulsive force is applied to the circuit board by disposing an elastically deformable portion of the compliant portion in the press-fit hole of the circuit board, it is possible to reduce a load on the circuit board caused by the press-fitting of the press-fit terminal into the press-fit hole of the circuit board.

[2] The method according to the above [1], wherein
the compliant portion (23) includes
   a pair of elastic portions (24) spaced apart from each other in the width direction and extending in the press-fit direction to define the through hole (25),
the pair of elastic portions (24) include
   a pair of first inclined portions (24a) disposed on a base end side (upper side) of the pair of elastic portions (24) in the press-fit direction, and extending in such a way to separate from each other in the width direction (left-right direction) from the base end side (upper side) toward a tip end side (lower side) of the pair of elastic portions in the press-fit direction,
   a pair of second inclined portions (24c) disposed on the tip end side (lower side), and extending in such a way to approach each other in the width direction (left-right direction) from the base end side (upper side) toward the tip end side (lower side), and
   a pair of contact portions (24b) extending substantially linearly along the press-fit direction (upper-lower direction) in such a way to connect the pair of first inclined portions (24a) and the pair of second inclined portions (24c) in the press-fit direction, the pair of contact portions respectively pressed against the inner peripheral surface, and
in the abutting, a length of the pair of contact portions (24b) in the width direction (left-right direction) is larger than a hole diameter of the press-fit hole (3a).

According to the configuration of the above [2], since the length between the contact surfaces of the pair of contact portions in the width direction is larger than the hole diameter of the press-fit hole, connection reliability between the press-fit terminal and the circuit board is improved.

[3] The method according to the above [2], wherein
the tip end portion (lower end portion 26) is disposed lower than the pair of contact portions (24b), and
the base end portion (upper end portion 27) is disposed upper than the pair of contact portions (24b).

According to the configuration of the above [3], since the pair of contact portions are positioned upper than the tip end portion of the through hole and are positioned lower than the base end portion of the through hole, only an intended repulsive force is applied to the circuit board, so that it is possible to reduce the load of the circuit board caused by the press-fitting of the press-fit terminal into the press-fit hole of the circuit board.

[4] The method according to any one of the above [1] to [3], wherein
the through hole (25) has a substantially elliptical shape.

According to the configuration of the above [4], since the through hole has a substantially elliptical shape, adjustment (for example, an amount of elastic deformation or the like) relating to elastic deformation of the compliant portion can be easily made.

[5] The method according to the above [2], wherein
a length of the pair of contact portions (24b) in the press-fit direction (upper-lower direction) is larger than a thickness of the circuit board.

According to the configuration of the above [5], since the length the pair of contact portions in the press-fit direction is larger than the thickness of the circuit board, connection reliability between the press-fit terminal and the circuit board is improved.

1. A method for manufacturing a board-equipped connector,
the board-equipped connector including a circuit board having a press-fit hole, and a connector mounted on the circuit board,
the connector including
a press-fit terminal having one end side press-fitted into the press-fit hole of the circuit board in a press-fit direction, and
a housing holding the press-fit terminal,
the press-fit terminal including
a compliant portion having both side portions disposed in a width direction of the press-fit terminal and pressed against an inner peripheral surface of the press-fit hole, the width direction intersecting the press-fit direction,
the compliant portion having a through hole penetrating in a plate thickness direction of the press-fit terminal and extending along the press-fit direction, the plate thickness direction intersecting the press-fit direction and the width direction,
the method comprising mounting the connector to the circuit board, and
the mounting comprising:
abutting the compliant portion against the inner peripheral surface such that a tip end portion of the through hole in the press-fit direction is disposed within the press-fit hole,
press-fitting the compliant portion into the press-fit hole, and
stopping press-fitting the compliant portion into the press-fit hole such that a base end portion of the through hole in the press-fit direction is disposed upper than an upper surface of the circuit board.

2. The method according to claim 1, wherein
the compliant portion includes
a pair of elastic portions spaced apart from each other in the width direction and extending in the press-fit direction to define the through hole,
the pair of elastic portions include
a pair of first inclined portions disposed on a base end side of the pair of elastic portions in the press-fit direction, and extending in such a way to separate from each other in the width direction from the base end side toward a tip end side of the pair of elastic portions in the press-fit direction,
a pair of second inclined portions disposed on the tip end side, and extending in such a way to approach each other in the width direction from the base end side toward the tip end side, and
a pair of contact portions extending substantially linearly along the press-fit direction in such a way to connect the pair of first inclined portions and the pair of second inclined portions in the press-fit direction, the pair of contact portions respectively pressed against the inner peripheral surface, and
in the abutting, a length of the pair of contact portions in the width direction is larger than a hole diameter of the press-fit hole.

3. The method according to claim 2, wherein
the tip end portion is disposed lower than the pair of contact portions, and
the base end portion is disposed upper than the pair of contact portions.

4. The method according to claim 1, wherein
the through hole has a substantially elliptical shape.

5. The method according to claim 2, wherein
a length of the pair of contact portions in the press-fit direction is larger than a thickness of the circuit board.
